(19) United States
(12) Patent Application Publication
(10) Pub. No.: US 2025/0262984 A1
(43) Pub. Date: Aug. 21, 2025

(54) HYBRID ELECTRIC VEHICLE ENERGY MANAGEMENT

(71) Applicant: FCA US LLC, Auburn Hills, MI (US)

(72) Inventors: Zhentao Xie, Auburn Hills, MI (US); Rudolf Kharpuri, Auburn Hills, MI (US)

(21) Appl. No.: 18/443,937

(22) Filed: Feb. 16, 2024

(51) Int. Cl. B60L 58/18; B60K 6/26; B60K 6/28; B60W 20/00

(52) U.S. Cl. CPC B60L 58/18; B60K 6/26; B60K 6/28; B60W 20/00; B60L 2210/10; B60L 2240/545; B60Y 2200/92

(57) ABSTRACT

A hybrid electric vehicle (HEV) includes an internal combustion engine, an electric traction motor, a belt starter generator (BSG) unit, a low voltage battery system including a low voltage battery, a high voltage battery system including a high voltage traction battery, and a DC/DC converter. A powertrain control system, for managing the DC/DC converter and the BSG unit to charge and maintain the low voltage battery system, includes a controller having one or more processors programmed to (i) control the DC/DC converter to supply power output to the low voltage battery system while the BSG unit is disabled, (ii) monitor the DC/DC converter power output, (iii) detect when the DC/DC converter power output exceeds a predetermined threshold and a new low voltage power load is requested, and subsequently enable the BSG unit to provide additional power output to satisfy the requested new low voltage power load.

### FIELD

The present application relates generally to hybrid electric vehicle control systems and, more particularly, to a vehicle control system for power supply energy management to charge and maintain a low voltage power system.

### BACKGROUND

A plug-in hybrid-electric vehicle (PHEV) powertrain typically includes a high voltage battery system and a low voltage (e.g., 12 volt) battery system. In such a configuration, the high voltage battery system is utilized to power the electric motor and power/recharge the low voltage battery system via a direct current to direct current (DC/DC) converter. However, additional 12V loads, such as autonomous driving modules, can potentially saturate the DC/DC when the electrical load demand exceeds the maximum output of the DC/DC. Additionally, the DC/DC can go into a self-protection mode to limit the power output. Under such conditions, the low voltage system voltage may drop below a normal operating threshold, which could lead to rapid depletion of the battery and eventual loss of propulsion. Accordingly, while such conventional systems do work well for their intended purpose, there is a desire for improvement in the relevant art.

### SUMMARY

In accordance with one example aspect of the invention, a hybrid electric vehicle (HEV) is provided. In one example implementation, the HEV includes an internal combustion engine, an electric traction motor, a belt starter generator (BSG) unit configured to start the internal combustion engine and generate electricity, a low voltage battery system including a low voltage battery electrically coupled to the BSG unit for recharging thereby, a high voltage battery system including a high voltage traction battery configured to power the electric traction motor, and a DC/DC converter configured to convert high voltage from the high voltage battery system into low voltage to charge the low voltage battery and support low voltage loads. A powertrain control system, for managing the DC/DC converter and the BSG unit to charge and maintain the low voltage battery system, includes a controller having one or more processors programmed to (i) control the DC/DC converter to supply power output to the low voltage battery system while the BSG unit is disabled, (ii) monitor the DC/DC converter power output, (iii) detect when the DC/DC converter power output exceeds a predetermined threshold and a new low voltage power load is requested, and subsequently enable the BSG unit to provide additional power output to satisfy the requested new low voltage power load.

In addition to the foregoing, the described HEV may include one or more of the following features: wherein the controller is further programmed to hold the new power load requests until the BSG unit has ramped up to a desired output voltage set point; wherein the controller is further programmed to control an output voltage set point of the DC/DC converter and the output voltage set point of the BSG unit to satisfy the requested new low voltage power load; and wherein the controller is further programmed to determine if (i) the DC/DC converter power output is below a second predetermined threshold, and (ii) low voltage power load requests are decreasing.

In addition to the foregoing, the described HEV may include one or more of the following features: wherein if (i) and (ii) are true, the controller is programmed to ramp down the BSG unit power output; wherein if the BSG unit power output is below a third predetermined threshold or if a ramping down timer has expired, the controller is further programmed to shut off the BSG unit; wherein the powertrain control system further includes an auxiliary power module (APM) in signal communication with the controller and configured to control the output voltage setpoint of the DC/DC converter, and a motor control processor (MCP) in signal communication with the controller and configured to control the output voltage setpoint of the BSG unit; and wherein the powertrain control system further includes an intelligent battery sensor (IBS) system configured to monitor a temperature and state of charge (SOC) of the low voltage battery.

In accordance with another example aspect of the invention, a method of operating a powertrain control system of a hybrid electric vehicle (HEV) is provided. The HEV includes an internal combustion engine, an electric traction motor, a belt starter generator (BSG) unit, a low voltage battery system including a low voltage battery, and a DC/DC converter. In one example implementation, the method includes (i) controlling, by a controller having one or more processors, the DC/DC converter to supply power output to the low voltage battery system while the BSG unit is disabled, (ii) monitoring, by the controller, the DC/DC converter power output, (iii) detecting, by the controller, when the DC/DC converter power output exceeds a predetermined threshold and a new low voltage power load is requested, and (iv) subsequently enabling, by the controller, the BSG unit to provide additional power output to satisfy the requested new low voltage power load.

In addition to the foregoing, the described method may include one or more of the following features: holding, by the controller, the new power load request until the BSG unit has ramped up to a desired output voltage set point; controlling, by the controller, an output voltage set point of the DC/DC converter and the output voltage set point of the BSG unit to satisfy the requested new low voltage power load; determining, by the controller, if (i) the DC/DC converter power output is below a second predetermined threshold and (ii) low voltage power load requests are decreasing; and if (i) and (ii) are true, ramping down the BSG unit power output via the controller.

In addition to the foregoing, the described method may include one or more of the following features: wherein if the BSG unit power output is below a third predetermined threshold or if a ramping down timer has expired, the controller is configured to shut off the BSG unit; wherein the powertrain control system further includes an auxiliary power module (APM) in signal communication with the controller and configured to control the output voltage setpoint of the DC/DC converter, and a motor control processor (MCP) in signal communication with the controller and configured to control the output voltage setpoint of the BSG unit; and wherein the powertrain control system further includes an intelligent battery sensor (IBS) system configured to monitor a temperature and state of charge (SOC) of the low voltage battery.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic illustration of an example hybrid electric vehicle (HEV) architecture in accordance with the principles of the present application;

FIG. 2 is an example graph illustrating an example control sequence of the HEV shown in FIG. 1, in accordance with the principles of the present application; and

FIGS. 3A-3B illustrate an example control logic flow for operating an electrified powertrain system of the HEV shown in FIG. 1, in accordance with the principles of the present application.

### DETAILED DESCRIPTION

As discussed above, the hybrid electric vehicle (HEV) powertrain includes a high voltage battery system and a low voltage battery system. The low voltage battery system can be powered/recharged by the DC/DC converter or a 12V belt starter generator. However, depending on vehicle equipment and accessories, additional 12V load may exceed the DC/DC converter maximum output or limit the power output. This may cause the 12V system voltage to drop below the normal operating threshold, leading to rapid depletion of the 12V battery and eventual loss of propulsion. Accordingly, described herein are systems and methods to control both the DC/DC converter and a 12V belt-start generator (BSG) to supply enough power for the 12V system when the 12V loads request is beyond the DC/DC maximum power output.

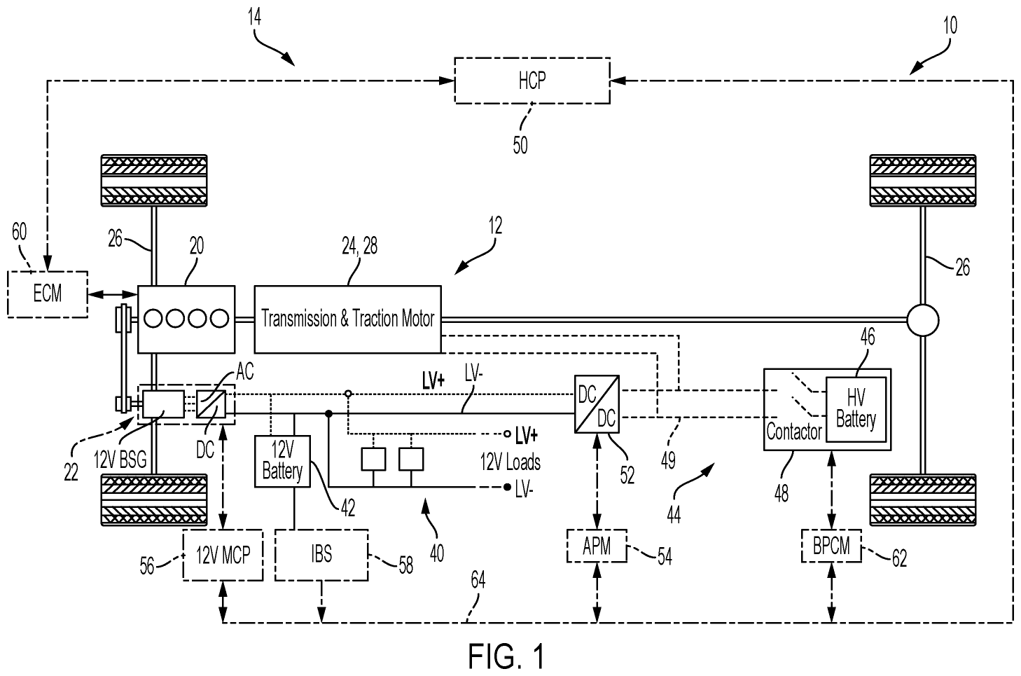

With initial reference to FIG. 1, a schematic diagram of a plug-in hybrid electric vehicle (PHEV) 10 is illustrated having a hybrid powertrain 12 and a powertrain control system 14 according to example implementations of the disclosure. In the illustrated example, the powertrain 12 generally includes an internal combustion engine 20 and two electric motors, including a low voltage (e.g., 12V) belt-driven starter generator (BSG) and inverter unit 22 (e.g., P1 motor), and a higher voltage (e.g., 400V) electric traction motor 24 as part of a hybrid transmission 28.

The engine 20 combusts a mixture of air and fuel (e.g., gasoline) within cylinders to drive pistons and generate drive torque to a front or rear axle 26 via transmission 28. The electric motor of the BSG unit 22 is utilized to control engine stop/start operations to improve vehicle fuel economy, and the electric traction motor 24 is configured to selectively provide drive torque to the front and/or rear axle 26. In one example embodiment, the transmission 28 is a hybrid dual clutch transmission that generally includes a first clutch, a second clutch, a first sub-transmission with odd gear ratios, and a second sub-transmission with even gear ratios. It will be appreciated, however, that transmission 28 may have any suitable configuration that enables HEV 10 to function as described herein.

To provide electric power, the PHEV 10 includes a low voltage battery system 40 having a battery 42, and a high voltage (HV) battery system 44 having a HV traction battery 46. In the example description, the low voltage battery system 40 is a 12V system and the HV battery system 44 is a 400V system and will be described as such. However, it will be appreciated that systems 40, 44 may have different operating voltages.

In the example embodiment, the low voltage battery system 40 is configured to support various 12V loads of the PHEV 10, for example, to power various electrical components or start the engine 20. The high voltage battery system 44 is configured to power high voltage loads such as the traction motor 24 and a DC/DC converter. A contactor 48 is included as an electromechanical switching device utilized to selectively connect the HV battery 46 to a high voltage bus 49 of the HV battery system 44. In some examples, the contactor 48 is integrated with the HV battery 46. In general, the electric traction motor 24 is powered by the HV battery system 44, and the low voltage BSG unit 22 is powered by the 12V battery system 40 and/or the HV battery system 44.

In the example embodiment, the hybrid powertrain 12 is controlled by the powertrain control system 14, which generally includes a hybrid control processor (HCP) or controller 50, a DC/DC converter 52, an auxiliary power module (APM) 54, the 12V BSG unit 22, a 12V motor control processor (MCP) 56, an intelligent battery sensor (IBS) system 58, an engine control module (ECM) 60, and a battery pack control module (BPCM) 62.

The controller 50 is a central supervisory control configured to communicate with various components/modules of the hybrid powertrain 12 via a CAN bus 64. The DC/DC converter 52 is an actuator configured to convert high voltage (e.g., 48V) to low voltage (e.g., 12V) to charge the 12V battery 42 and support various 12V loads of the HEV 10. The APM 54 is a controller that controls the DC/DC converter 52. The APM 54 can monitor a status of the DC/DC converter 52 such as operation mode and failure status. The APM 54 can further measure an input and output current and voltage of the DC/DC converter 52. In addition, the APM 54 can control the DC/DC converter 52 to operate in a specific mode (e.g., boost mode, etc.) and/or reach specific voltage setpoints. The APM 54 can bi-directionally communicate with the hybrid controller 50 via the CAN bus 64. In this regard, the controller 50 can control and monitor the DC/DC converter 52 through the APM 54.

The BSG unit 22 is an actuator configured to be utilized as a starter when the HEV 10 needs to crank the engine 20. The BSG unit 22 is configured to operate in an alternator mode to charge the 12V battery 42 and support 12V loads while the engine 20 is running. The 12V BSG unit 22 is directly controlled by the MCP 56, which is a controller configured for bi-directional communication with the controller 50 via the CAN bus 64. The controller 50 is configured to control the BSG unit 22 by forwarding signals, such as operation state, torque command, and voltage setpoints to the 12V MCP 56, and the MCP 56 provides feedback signals to the controller 50 related to the BSG unit 22 such as operation status, output current, and voltage.

In the example embodiment, the IBS system 58 includes one or more sensors configured to monitor various conditions of the 12V battery 42 such as, for example, temperature, voltage, current, and state of charge (SOC). The IBS system 58 is in signal communication with controller 50. In this way, the IBS system 58 is configured to forward the 12V battery measurement signals to controller 50 via CAN bus 64 or alternatively a LIN bus.

The ECM 60 is configured to control engine 20 to provide torque and speed to drive the 12V BSG unit 22. The controller 50 is configured to control and monitor the engine 20 via the ECM 60. The BPCM 62 is configured to monitor various conditions of the HV battery 46, such as battery current, voltage, contactor status, as well as estimate SOC and charging/discharging power limits. The BPCM 62 is configured for bi-directional communication with the controller 50 via the CAN bus 64, and the controller 50 controls and monitors the HV battery pack 46 via the BPCM 62.

In operation, the powertrain control system 14 is configured to control both the BSG unit 22 and the DC/DC converter 52 together to provide enough power to support a high load request, which is larger than what the BSG unit 22 or the DC/DC converter 52 can provide alone. The system 14 includes a dedicated voltage control algorithm designed for both the BSG unit 22 and the DC/DC converter 52. For fuel economy considerations and energy savings purposes, the system also includes controls to enable/disable the BSG unit 22. Further, the system includes proactive controls to avoid stress on the 12V battery system 40 during incoming load surges or outgoing load dumps.

More specifically, during operation, the powertrain control system 14 is configured to perform four functions. The first function controls the DC/DC converter set point. For the first function, the controller 50 controls the DC/DC converter voltage set point based on the 12V battery SOC and HV battery power. The controller 50 sends the voltage set point command to the APM 54, and the APM 54 follows the command and regulates the DC/DC converter output voltage.

The second function includes proactively predicting load when it steps up/down to enable the BSG unit 22. The BSG unit 22 converts the engine kinetic energy to electrical energy. To optimize fuel economy, the BSG unit 22 is used as a secondary power supply to compensate any shortage of the DC/DC converter output. The controller 50 continuously monitors the 12V load request commands to predict the incoming loads. Anticipating incoming loads on the 12V system 40 facilitates avoiding under-voltage and over-voltage situations where the 12V battery 42 is stressed to discharge or absorb loads during transition as the loads come and go rapidly before the controller 50 realizes the change and can adjust the DC/DC output.

When the DC/DC converter output power is higher than a predefined threshold (e.g., 2.75 KW), and if there are any new load requests adding on, the controller 50 is configured to hold the new request (e.g., does not immediately provide the requested power). The controller 50 subsequently turns on the BSG unit 22 and ramps up the 12V BSG voltage to the desired set point. Once the BSG unit 22 is operating properly (e.g., meeting the set point), the controller 50 is configured to fulfill the new load request. Additionally, if the DC/DC converter 52 has already been saturated based on the scenario of bus voltage drop or the APM 54 reporting saturation, the controller 50 is configured to turn on the BSG unit 22 and hold any new load request until the saturation is resolved.

The third function controls the BSG unit voltage set point. To optimize vehicle fuel economy, the DC/DC converter 52 is configured to supply most of the power, and the BSG unit 22 compensates for any shortage of the DC/DC converter output. To provide this functionality, the 12V BSG voltage set point is higher than the 12V battery voltage, but slightly lower than the DC/DC output voltage. Accordingly, in the example embodiment, the 12V BSG voltage set point is designed to be half of the 12V battery voltage plus the DC/DC output voltage: 12V BSG Volt Set Point=½(12V battery volt+DC/DC output volt).

The fourth function determines the conditions to disable the BSG unit 22. When the total 12V output power is less than a predetermined threshold, and the DC/DC converter 52 is no longer saturated, the controller 50 is configured to ramp down the 12V BSG voltage set point (e.g., power output). Once the 12V BSG output power is less than a predetermined threshold or a ramping down timer is expired, the controller 50 is configured to disable the BSG unit 22 and only utilize the DC/DC converter 52 to supply the 12V system 40.

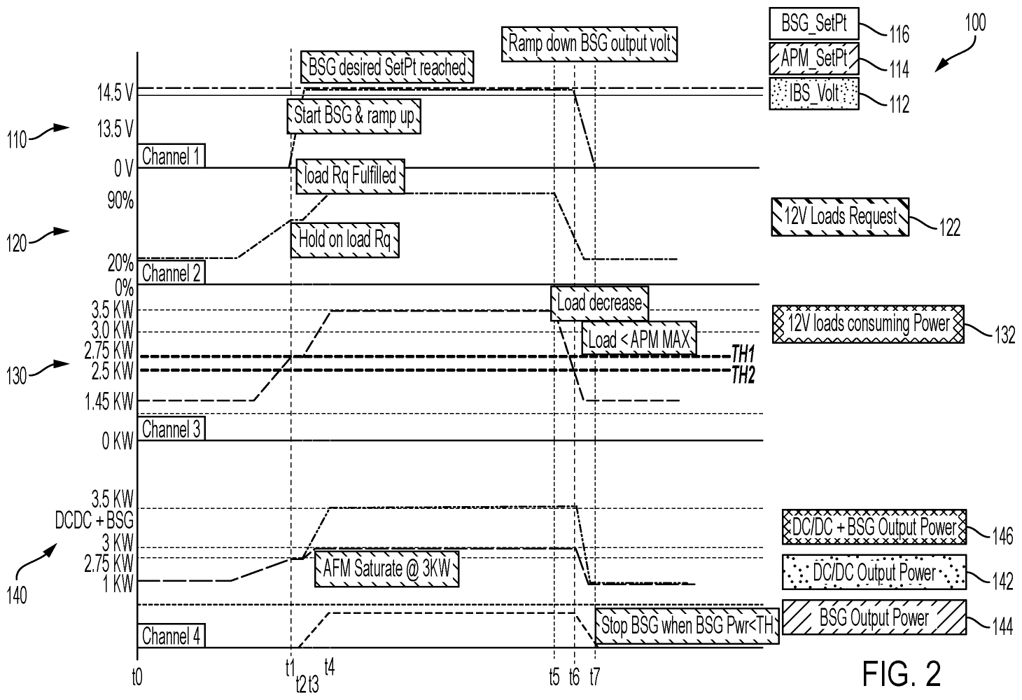

With reference now to FIG. 2, an example operation of the powertrain control system 14 to perform energy management of the BSG unit 22 and the DC/DC converter 52 to charge and maintain the 12V battery system 40 is described in more detail. In the example implementation, FIG. 2 illustrates a graph 100 showing a first channel 110, a second channel 120, a third channel 130, and a fourth channel 140. The first channel 110 illustrates an IBS_Volt 112, an APM_SetPt 114, and a BSG_SetPt 116. The IBS_Volt 112 indicates an actual voltage measurement of the 12V battery 42 via the IBS system 58. The APM_SetPt 114 is a predetermined 12V battery charge target. The BSG_SetPt 116 is a BSG unit output voltage set point.

The second channel 120 illustrates a 12V load request 122 on the 12V battery system 40. The third channel 130 illustrates a 12V load power consumption 132 with a first threshold ‘TH1’ and a second threshold ‘TH2’. In the example embodiment, the first threshold ‘TH1’ is a predetermined threshold close to the DC/DC converter max output 134 (e.g., 3 KW), in this case, approximately 2.75 KW. This threshold ‘TH1’ is a predetermined threshold condition indicating when the BSG unit 22 should be turned on to supplement the DC/DC converter power output. The second threshold ‘TH2’ is a predetermined threshold (e.g., 2.5 KW) below threshold ‘TH1’ indicating when the BSG unit 22 power output should be ramped down, due to a decreasing load request. The fourth channel 140 illustrates a DC/DC power output 142, a BSG power output 144, and a combined DC/DC and BSG power output 146.

In the example shown in FIG. 2, from time to t0 time t1, the DC/DC converter 52 is on and the BSG unit 22 is off. As shown in the second channel 120, the 12V load request 122 begins to increase. At time t1, the 12V system power consumption exceeds the first threshold ‘TH1’ (e.g., 2.75 KW), as shown in the third channel 130. At this point, controller 50 places a hold to any new 12V load request (e.g., does not provide more power), and subsequently enables the BSG unit 22, as shown in the first channel 110. In the example implementation, “placing a hold” means controlling a load actuation (e.g., fan speed) from going high until there is power to support the high speed, so the load demand does not increase even though the request increases. Placing such a hold request may indicate power is saturated, hence the request, and the hold may also delay the load actuation to allow the system to catch up and meet the load demand. The BSG output voltage ramps up to the desired BSG_SetPt=(DC/DC_LV_Volt+IBS_Volt)/2.

At time t2, the BSG unit 22 has reached the desired set point power output, as shown in the first channel 110, and both the DC/DC converter 52 and the BSG unit 22 are providing power, as shown in the fourth channel 140. In this way, the new load requests are now fulfilled, as shown in the second channel 120. At time t3, the DC/DC converter 52 is saturated (e.g., at 3 KW) and the BSG unit 22 compensates the offset power (e.g., above 3 KW), as shown in the fourth channel 140.

At time t4, the 12V loads consuming power arrive at a maximum (e.g., 3.5 KW), as shown in the third channel 130. At time t5, the 12V loads consuming power decrease (e.g., a fan is shut off). At time t6, the 12V system power consumption drops below the second threshold TH2. Controller 50 then ramps down the BSG output voltage set point to a minimum, as shown in the first channel 110. Finally, controller 50 turns off the BSG unit 22 when the 12V BSG power is below a predetermined threshold, as shown in the fourth channel 140.

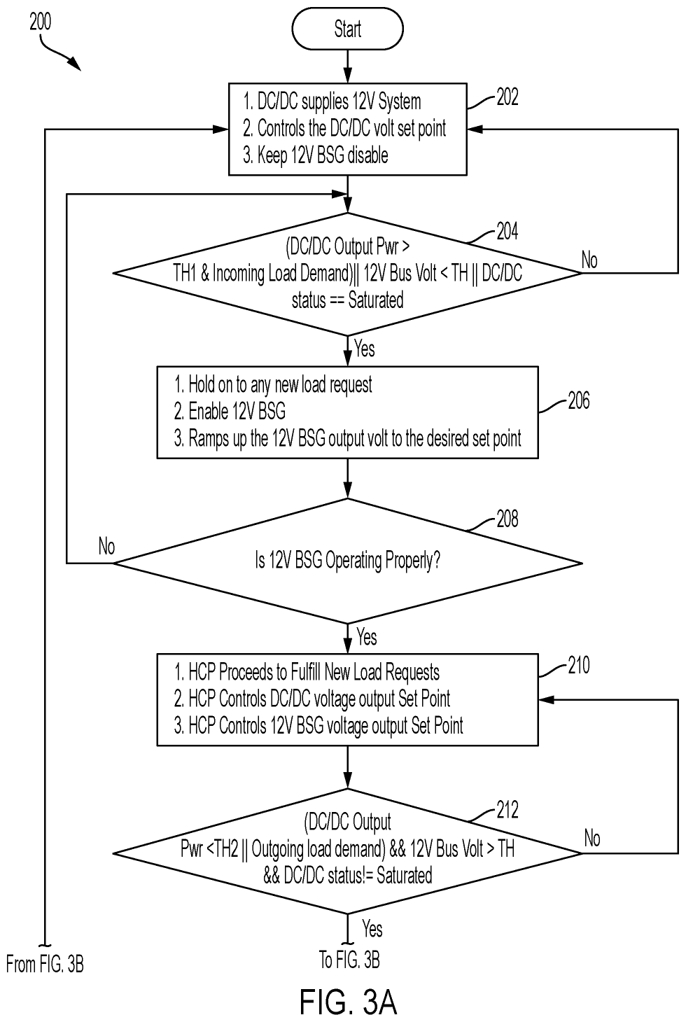

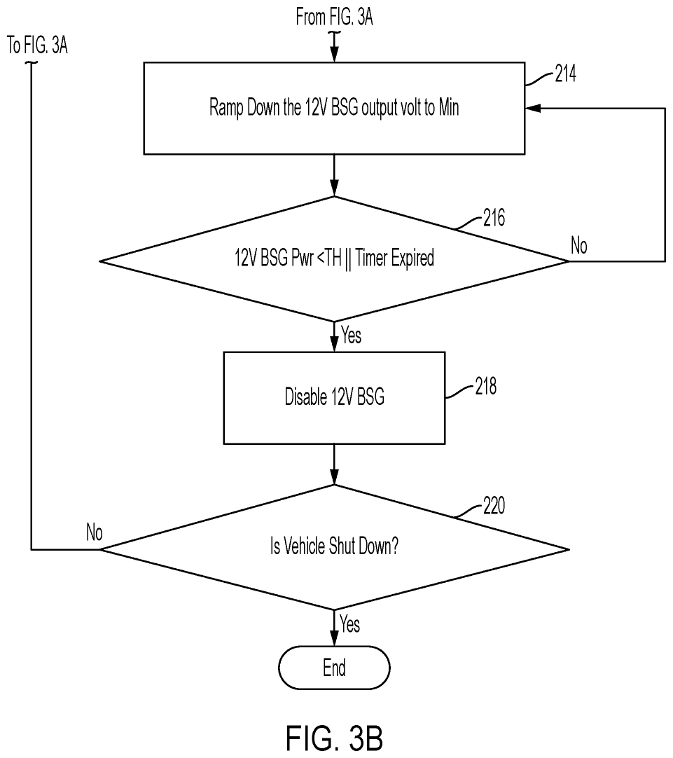

With reference now to FIGS. 3A-3B, an example control logic flow 200 for operating the powertrain control system 14 to manage power supplies to charge and maintain the 12V battery system 40 is provided. At step 202, the DC/DC converter 52 supplies power to the 12V battery system 40, and control (e.g., controller 50) controls the DC/DC voltage set point, for example, based on the 12V battery SOC and temperature, and the HV battery SOC and battery power. Control also maintains the BSG unit 22 off/disabled.

At step 204, control monitors the DC/DC converter 52 sensor readings transmitted by the APM 54, and determines if the DC/DC output power is greater than the first threshold TH1 and incoming load demands are present, or the 12V bus voltage is less than a predetermined threshold, or the DC/DC converter 52/APM 54 is determined to be saturated. If no, control returns to step 202. If yes, control proceeds to step 206.

At step 206, control holds the new power load request(s), enables the BSG unit 22, and subsequently ramps up the BSG power output voltage to the desired set point. At step 208, control determines if the BSG unit 22 is operating properly (e.g., providing the desired set point). If no, control returns to step 204. If yes, control proceeds to step 210.

At step 210, control proceeds to fulfill the new 12V power load requests when the BSG unit 22 is operating properly. Controller 50 controls the DC/DC output voltage set point, and also controls the 12V BSG output voltage set point. At step 212, control determines if the total output power of the DC/DC converter 52 and the BSG unit 22 is less than a predetermined threshold TH2 (e.g., outgoing load demand), and the 12V bus voltage is greater than a second predetermined threshold, and the DC/DC converter 52 is not saturated. In the example embodiment, the DC/DC threshold is the saturation value above which the DC/DC cannot meet any more demands, and below which the DC/DC can support all demands. The 12V bus volt threshold is a value above which the 12V system is operational and not supporting additional loads the DC/DC cannot support, and below which the 12V system is depleting because of additional loads coming in (e.g., when the DC/DC is not able to support those loads). If no, control returns to step 210. If yes, control proceeds to step 214.

At step 214, controller 50 commands a ramp down of the 12V BSG output voltage to a minimum. At step 216, control determines if the 12V BSG power output is less than a threshold where the BSG unit 22 is no longer needed to support additional loads, or a ramping down timer is expired. If no, control returns to step 214. If yes, control proceeds to step 218 and disables/turns off the BSG unit 22. At step 220, control determines if the vehicle is shut down. If no, control returns to step 202. If yes, control ends.

Described herein are systems and methods for power supply management to charge and maintain a 12V battery system of a PHEV. A powertrain control system monitors various components on a low voltage battery system and a high voltage battery system. A DC/DC converter supplies the 12V system loads until the 12V load requests exceed a threshold. At this point, the control system holds the new load requests and selectively enables a BSG unit to facilitate satisfying the new load requests. Such control enables vehicles to handle additional 12V loads and reduces fuel consumption, thereby increasing vehicle efficiency.

It will be appreciated that the term “controller” or “module” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A hybrid electric vehicle (HEV), comprising:
an internal combustion engine;
an electric traction motor;
a belt starter generator (BSG) unit configured to start the internal combustion engine and generate electricity;
a low voltage battery system including a low voltage battery electrically coupled to the BSG unit for recharging thereby;
a high voltage battery system including a high voltage traction battery configured to power the electric traction motor;
a DC/DC converter configured to convert high voltage from the high voltage battery system into low voltage to charge the low voltage battery and support low voltage loads; and
a powertrain control system for managing the DC/DC converter and the BSG unit to charge and maintain the low voltage battery system, including a controller having one or more processors programmed to:
control the DC/DC converter to supply power output to the low voltage battery system while the BSG unit is disabled;
monitor the DC/DC converter power output;
detect when the DC/DC converter power output exceeds a predetermined threshold and a new low voltage power load is requested; and
subsequently enable the BSG unit to provide additional power output to satisfy the requested new low voltage power load.

2. The HEV of claim 1, wherein the controller is further programmed to hold the new power load requests until the BSG unit has ramped up to a desired output voltage set point.

3. The HEV of claim 2, wherein the controller is further programmed to control an output voltage set point of the DC/DC converter and the output voltage set point of the BSG unit to satisfy the requested new low voltage power load.

4. The HEV of claim 1, wherein the controller is further programmed to determine if (i) the DC/DC converter power output is below a second predetermined threshold, and (ii) low voltage power load requests are decreasing.

5. The HEV of claim 4, wherein if (i) and (ii) are true, the controller is programmed to ramp down the BSG unit power output.

6. The HEV of claim 5, wherein if the BSG unit power output is below a third predetermined threshold or if a ramping down timer has expired, the controller is further programmed to shut off the BSG unit.

7. The HEV of claim 1, wherein the powertrain control system further includes:
an auxiliary power module (APM) in signal communication with the controller and configured to control the output voltage setpoint of the DC/DC converter; and
a motor control processor (MCP) in signal communication with the controller and configured to control the output voltage setpoint of the BSG unit.

8. The HEV of claim 7, wherein the powertrain control system further includes:
an intelligent battery sensor (IBS) system configured to monitor a temperature and state of charge (SOC) of the low voltage battery.

9. A method of operating a powertrain control system of a hybrid electric vehicle (HEV) having an internal combustion engine, an electric traction motor, a belt starter generator (BSG) unit, a low voltage battery system including a low voltage battery, and a DC/DC converter, the method comprising:
controlling, by a controller having one or more processors, the DC/DC converter to supply power output to the low voltage battery system while the BSG unit is disabled;
monitoring, by the controller, the DC/DC converter power output;
detecting, by the controller, when the DC/DC converter power output exceeds a predetermined threshold and a new low voltage power load is requested; and
subsequently enabling, by the controller, the BSG unit to provide additional power output to satisfy the requested new low voltage power load.

10. The method of claim 9, further comprising holding, by the controller, the new power load request until the BSG unit has ramped up to a desired output voltage set point.

11. The method of claim 10, further comprising controlling, by the controller, an output voltage set point of the DC/DC converter and the output voltage set point of the BSG unit to satisfy the requested new low voltage power load.

12. The method of claim 9, further comprising:
determining, by the controller, if (i) the DC/DC converter power output is below a second predetermined threshold and (ii) low voltage power load requests are decreasing.

13. The method of claim 12, further comprising:
if (i) and (ii) are true, ramping down the BSG unit power output via the controller.

14. The method of claim 13, wherein if the BSG unit power output is below a third predetermined threshold or if a ramping down timer has expired, the controller is configured to shut off the BSG unit.

15. The method of claim 9, wherein the powertrain control system further includes:
an auxiliary power module (APM) in signal communication with the controller and configured to control the output voltage setpoint of the DC/DC converter; and
a motor control processor (MCP) in signal communication with the controller and configured to control the output voltage setpoint of the BSG unit.

16. The method of claim 15, wherein the powertrain control system further includes:
an intelligent battery sensor (IBS) system configured to monitor a temperature and state of charge (SOC) of the low voltage battery.
